(19) United States
(12) Patent Application Publication
(10) Pub. No.: US 2020/0100056 A1
(43) Pub. Date: Mar. 26, 2020

(54) INFORMATION PROCESSING SYSTEM, INFORMATION PROCESSING APPARATUS, AND NON-TRANSITORY COMPUTER READABLE MEDIUM

(71) Applicant: FUJI XEROX CO., LTD., Tokyo (JP)

(72) Inventor: Kentaro TAKANO, Kanagawa (JP)

(73) Assignee: FUJI XEROX CO., LTD., Tokyo (JP)

(21) Appl. No.: 16/257,016

(22) Filed: Jan. 24, 2019

(30) Foreign Application Priority Data
Sep. 20, 2018 (JP) 2018-176349

(51) Int. Cl. H04W 4/02; H04N 1/00; H04W 4/70

(52) U.S. Cl. CPC H04W 4/023; H04W 4/70; H04N 1/00137

(57) ABSTRACT

An information processing system includes a position detector and a terminal apparatus identifying unit. The position detector detects a position of a terminal apparatus capable of receiving information that is provided. The terminal apparatus identifying unit identifies, as a terminal apparatus to which the information is provided, a terminal apparatus positioned at a predetermined position and associated with a user who belongs to a disclosure range of the information that is provided.

### CROSS-REFERENCE TO RELATED APPLICATIONS

This application is based on and claims priority under 35 USC 119 from Japanese Patent Application No. 2018-176349 filed Sep. 20, 2018.

### BACKGROUND

### (i) Technical Field

The present disclosure relates to an information processing system, an information processing apparatus, and a non-transitory computer readable medium.

### (ii) Related Art

Japanese Unexamined Patent Application Publication No. 2008-299374 discloses a process of obtaining a first distribution destination candidate group specified for document information, obtaining a second distribution destination candidate group set in advance in association with disclosure range defining information, and determining a distribution destination of the document information by a logical operation based on the first distribution destination candidate group and the second distribution destination candidate group.

Japanese Unexamined Patent Application Publication No. 2018-5724 discloses a process of giving a right to access an electronic file to a user selected from a user list by a selectin operation of an operating user.

PCT Publication No. 08/90779 discloses a configuration for checking the validity of a partner by approaching a disclosure target with a right to receive disclosure and monitoring the disclosure target.

In the case of providing information to a terminal apparatus, if there are many candidates for a terminal apparatus to which information is providable, the user may need to, for example, select from among these many candidates a destination to which information is provided. In this case, the operation becomes complicated, or transmission to a wrong destination tends to occur more readily. In addition, in the case of providing information to a terminal apparatus, in a configuration where information is provided to all terminal apparatuses to which information is providable, information is provided to those who do not need it in the first place.

### SUMMARY

Aspects of non-limiting embodiments of the present disclosure relate to narrowing down information-providing destinations to some specific destinations.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a position detector and a terminal apparatus identifying unit. The position detector detects a position of a terminal apparatus capable of receiving information that is provided. The terminal apparatus identifying unit identifies, as a terminal apparatus to which the information is provided, a terminal apparatus positioned at a predetermined position and associated with a user who belongs to a disclosure range of the information that is provided.

### BRIEF DESCRIPTION OF THE DRAWINGS

An exemplary embodiment of the present disclosure will be described in detail based on the following figures, wherein:

FIG. 1 is a diagram illustrating the configuration of an information processing system;

FIGS. 2A and 2B are diagrams illustrating a display screen of an instruction apparatus after a process indicated by reference symbol 1D in FIG. 1 is executed;

FIG. 3 is a diagram illustrating another display example of the instruction apparatus;

FIG. 4 is a diagram illustrating the configuration of hardware of a document server;

FIG. 5 is a diagram illustrating function units included in the document server;

FIG. 6 is a diagram illustrating the configuration of hardware of the instruction apparatus;

FIG. 7 is a diagram illustrating function units included in the instruction apparatus;

FIG. 8 is a diagram illustrating the flow of a process executed in the information processing system;

FIG. 9 is a diagram describing a process of changing a display format;

FIG. 10 is a diagram illustrating a display screen of a partner terminal apparatus in the case where information regarding a place and a time for providing a document is output to the partner terminal apparatus;

FIGS. 11A and 11B are diagrams illustrating the flow of a process in the case of providing a document at a predetermined position at a predetermined time;

FIG. 12 is a diagram describing another example of a document providing form; and

FIG. 13 is a diagram illustrating the flow of a process in the case of providing a document in the document providing form illustrated in FIG. 12.

### DETAILED DESCRIPTION

Hereinafter, an exemplary embodiment of the present disclosure will be described with reference to the accompanying drawings.

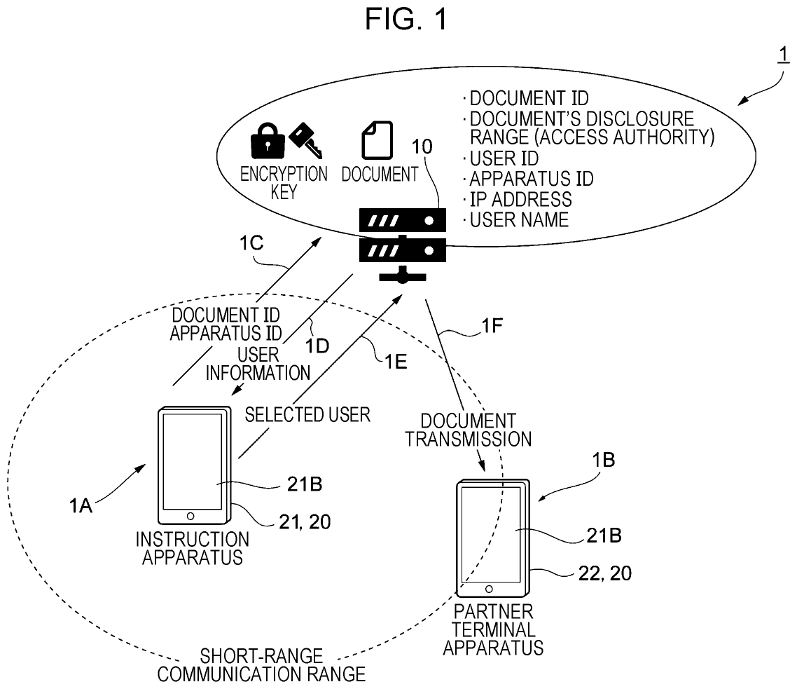

FIG. 1 is a diagram illustrating the configuration of an information processing system 1 according to the present exemplary embodiment.

As illustrated in FIG. 1, the information processing system 1 according to the present exemplary embodiment includes a document server 10, which stores one or more documents (document information). The information processing system 1 further includes a plurality of terminal apparatuses 20, which serve as an example of an information processing apparatus.

Each of the terminal apparatuses 20 includes a display 21B. The display 21B includes, for example, a touchscreen display (display device), and displays information for an operator.

In the present exemplary embodiment, in response to a transmission instruction from one terminal apparatus 20 (terminal apparatus 20 indicated by reference symbol 1A), the document server 10 transmits (provides) a document to another terminal apparatus 20 (terminal apparatus 20 indicated by reference symbol 1B).

In the following specification, a terminal apparatus 20 that gives an instruction to transmit a document will be referred to as an instruction apparatus 21, and a terminal apparatus 20 that receives the provided document will be referred to as a partner terminal apparatus 22. In addition, the terminal apparatuses 20 will be collectively referred to as a terminal apparatus 20 in the case where no distinction is made between each of the terminal apparatuses 20.

The instruction apparatus 21 and the partner terminal apparatus 22 are capable of communicating with each other using a short-range communication system such as Bluetooth (registered trademark).

In addition, the document server 10 transmits a document to the partner terminal apparatus 22 using a wireless communication system of the related art.

The document server 10 stores a plurality of documents (document information). The document server 10 further stores a document ID for identifying each of the documents and information regarding the disclosure range of each document (access authority) in association with each document.

At the time of creating a document, a person who creates the document sets the disclosure range of the document (sets those who are permitted to refer to the document). In the present exemplary embodiment, information regarding this disclosure range is also stored in the document server 10.

Setting of the disclosure range of a document is not limited to the time at which the document is created. The disclosure range of a document may be set after the document is created.

The document server 10 further stores (registers) information regarding a user who uses the information processing system 1.

Specifically, the document server 10 stores a user name, a user ID which is identification information for identifying each user, an apparatus ID which is identification information for identifying a terminal apparatus 20 owned by the user, and an IP address of the terminal apparatus 20 owned by the user. Note that these items of information are stored in association with one another in the document server 10.

To use the information processing system 1 according to the present exemplary embodiment, the user inputs the user ID via the terminal apparatus 20. In the present exemplary embodiment, the apparatus ID of the terminal apparatus 20 and the input user ID are transmitted to the document server 10.

The document server 10 performs identity verification by verifying the apparatus ID and user ID transmitted to the document server 10 against apparatus IDs and user IDs stored in the document server 10.

Note that the document server 10 also stores other information such as an encryption key for encrypting a document to be transmitted.

In the present exemplary embodiment, a document is transmitted (provided) to the partner terminal apparatus 22 in response to an instruction from the instruction apparatus 21. Hereinafter, the process of transmitting a document will be described.

For transmission of a document to the partner terminal apparatus 22, an operator who operates the instruction apparatus 21 first operates the instruction apparatus 21 to select a document to be transmitted to the partner terminal apparatus 22. The instruction apparatus 21 accepts this selection.

The operator presses, for example, an OK button to give an instruction to transmit the selected document.

Accordingly, as indicated by reference symbol 10, a document ID for identifying the document selected by the operator is transmitted to the document server 10. At this time, the instruction apparatus 21 further transmits to the document server 10 an apparatus ID of one or more partner terminal apparatuses 22 positioned around the instruction apparatus 21.

In the present exemplary embodiment, the terminal apparatuses 20 including the instruction apparatus 21 mutually transmit/receive information by performing short-range communication. By performing short-range communication, the instruction apparatus 21 obtains the apparatus ID of each partner terminal apparatus 22 positioned around the instruction apparatus 21 (each partner terminal apparatus 22 positioned near the instruction apparatus 21 or each partner terminal apparatus 22 positioned within a predetermined distance from the instruction apparatus 21). In the present exemplary embodiment, this apparatus ID is transmitted to the document server 10.

The instruction apparatus 21 also outputs a document transmission instruction to the document server 10.

In response to transmission of the apparatus ID, document ID, and so forth from the instruction apparatus 21 to the document server 10, the document server 10 determines whether a user associated with each partner terminal apparatus 22 associated with the transmitted apparatus ID belongs to the disclosure range of a document associated with the document ID.

The document server 10 identifies a user who belongs to the disclosure range, and identifies a partner terminal apparatus 22 associated with the identified user. The document server 10 identifies this identified partner terminal apparatus 22 as a terminal apparatus 20 to which the document is provided.

Here, the apparatus ID transmitted to the document server 10 is the apparatus ID of a partner terminal apparatus 22 positioned near the instruction apparatus 21.

As a result, in the present exemplary embodiment, the document server 10 identifies a partner terminal apparatus 22 positioned near the instruction apparatus 21 and associated with a user who belongs to the disclosure range of the to-be-transmitted document as a terminal apparatus 20 to which the document is provided.

That is, in the present exemplary embodiment, the document server 10 uses the apparatus ID transmitted from the instruction apparatus 21 to detect the position of a partner terminal apparatus 22 associated with the apparatus ID.

Specifically, the document server 10 detects that the position of a partner terminal apparatus 22 associated with the apparatus ID is near the instruction apparatus 21.

In the present exemplary embodiment, the document server 10 identifies a partner terminal apparatus 22 positioned near the instruction apparatus 21 and associated with a user who belongs to the disclosure range of the to-be-transmitted document as a terminal apparatus 20 to which the document is provided.

In other words, the document server 10 identifies a partner terminal apparatus 22 positioned at a predetermined position and associated with a user who belongs to the disclosure range of the to-be-transmitted document as a terminal apparatus 20 to which the document is provided.

That is, the document server 10 identifies a partner terminal apparatus 22 having a predetermined positional relationship with the instruction apparatus 21 as a terminal apparatus 20 to which the document is provided. Specifically, the document server 10 identifies a partner terminal apparatus 22 within a predetermined distance from the instruction apparatus 21 as a terminal apparatus 20 to which the document is provided.

Thereafter, the document server 10 identifies a user associated with the partner terminal apparatus 22 identified as the terminal apparatus 20 to which the document is provided.

As indicated by reference symbol 1D in FIG. 1, the document server 10 transmits information regarding this identified user to the instruction apparatus 21.

The instruction apparatus 21 displays the information regarding the user, transmitted from the document server 10. In other words, the instruction apparatus 21 displays information regarding the user associated with the partner terminal apparatus 22 identified by the document server 10.

In the present exemplary embodiment, the operator operates the instruction apparatus 21 to select a user serving as a document transmission destination. That is, the operator selects a user serving as a document transmission destination from among a plurality of users displayed on the instruction apparatus 21.

Next, in the present exemplary embodiment, as indicated by reference symbol 1E, information regarding the selected user is transmitted to the document server 10.

Next, in the present exemplary embodiment, as indicated by reference symbol 1F, the document server 10 transmits the document to a partner terminal apparatus 22 associated with the selected user.

Accordingly, a series of processes from selection of a document by the instruction apparatus 21 to transmission of the document to the partner terminal apparatus 22 ends.

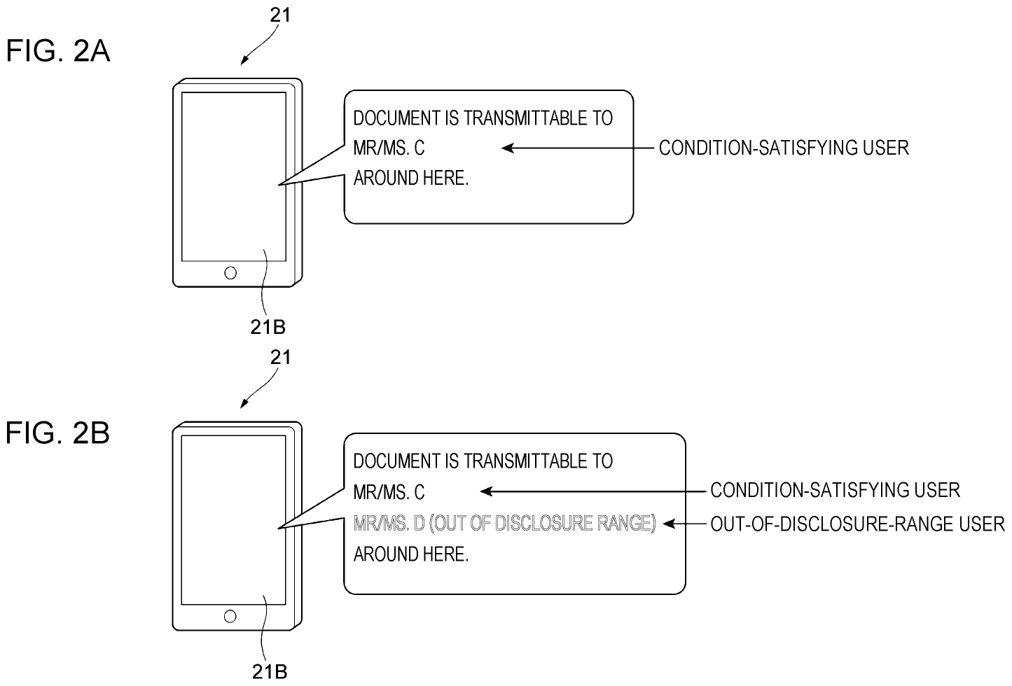

FIGS. 2A and 2B are diagrams illustrating a display screen of the instruction apparatus 21 after a process indicated by reference symbol 1D in FIG. 1 is executed.

In the present exemplary embodiment, as described above, the document server 10 transmits information regarding the identified user to the instruction apparatus 21, and, as illustrated in FIG. 2A, the instruction apparatus 21 displays the information regarding the user identified by the document server 10.

That is, the instruction apparatus 21 displays information regarding a user who is associated with a partner terminal apparatus 22 positioned near the instruction apparatus 21 and who belongs to the document's disclosure range.

In the display example illustrated in FIG. 2A, the illustrated exemplary case is that a user who is associated with a partner terminal apparatus 22 positioned near the instruction apparatus 21 and who belongs to the document's disclosure range is user C. In this case, as illustrated in FIG. 2A, user C is displayed as a candidate for the document transmission destination.

That is, the display 21B (display screen) of the instruction apparatus 21 displays that the document is transmittable to user C.

In the state illustrated in FIG. 2A, when the operator selects user C and presses an OK button (not illustrated) or the like, the document server 10 transmits the document to a partner terminal apparatus 22 associated with user C.

Although the case in which a document is stored in the document server 10 and the document is transmitted from the document server 10 to the partner terminal apparatus 22 has been described above, the transmission form is not limited to this case.

Alternatively, for example, a document stored in the instruction apparatus 21 may be once transmitted to the document server 10, and then the document server 10 may further transmit the document to the partner terminal apparatus 22.

With reference to FIG. 2A, the case in which a candidate for the document transmission destination is one person, namely, user C, has been described.

Alternatively, in the case where there is a plurality of partner terminal apparatuses 22 positioned near the instruction apparatus 21 and users associated with the plurality of partner terminal apparatuses 22 belong to the document's disclosure range, the instruction apparatus 21 displays these users serving as candidates for the document transmission destination.

More specifically, these users are arranged vertically on the display 21B and are displayed in the form of a list.

In this case, the operator who operates the instruction apparatus 21 selects a user, and the document is transmitted from the document server 10 to a partner terminal apparatus 22 associated with the selected user.

Here, in the configuration of the present exemplary embodiment, when the operator operates the instruction apparatus 21 to transmit the document, candidates for the transmission destination are narrowed down, thereby making it easier for the operator to specify the transmission destination.

Accordingly, the document may be transmitted in a shorter period of time. In addition, transmission of the document to a wrong destination becomes less likely to occur. That is, in the configuration of the present exemplary embodiment, compared with the case where all users who belong to the document's disclosure range are displayed on the instruction apparatus 21, the number of choices of the transmission destination is reduced, thereby transmitting the document more quickly.

Although information regarding one or more users serving as candidates for the transmission destination is displayed on the instruction apparatus 21 as described above in the present exemplary embodiment, a user serving as a candidate may already has the to-be-provided document.

In such a case, information indicating that the user already has the document may be displayed on the instruction apparatus 21, or display of a user who already has the document may be omitted on the instruction apparatus 21.

Although the case in which information regarding one or more users who are positioned near the instruction apparatus 21 and who belong to the disclosure range (hereinafter referred to as “condition-satisfying users”) is displayed has been described by way of example in the above description, users displayed on the instruction apparatus 21 are not limited to such condition-satisfying users.

For example, as illustrated in FIG. 2B, information regarding a user who does not belong to the document's disclosure range but is positioned near the instruction apparatus 21 (hereinafter referred to as an “out-of-disclosure-range user”) may be displayed on the instruction apparatus 21.

In other words, the instruction apparatus 21 may display, on the instruction apparatus 21, information regarding a user who does not belong to the disclosure range but is associated with a partner terminal apparatus 22 positioned near the instruction apparatus 21.

Note that, in this case, as illustrated in FIG. 2B, it is preferable that a condition-satisfying user (user C) and an out-of-disclosure-range user (user D) be distinctively displayed.

Specifically, in the display example illustrated in FIG. 2B, the color of the condition-satisfying user (user C) and the color of the out-of-disclosure-range user (user D) are made different.

Furthermore, in this display example, the text “out of disclosure range” is displayed next to a portion where the out-of-disclosure-range user (user D) is displayed, while the text “out of disclosure range” is not displayed next to a portion where the condition-satisfying user (user C) is displayed. In this way, the condition-satisfying user and the out-of-disclosure-range user are distinctively displayed.

That is, in the display example illustrated in FIG. 2B, for user D who is an out-of-disclosure-range user, display indicating that the user is outside the disclosure range is performed; for user C who is a condition-satisfying user, display indicating that the user is outside the disclosure range is not performed. In this way, the condition-satisfying user and the out-of-disclosure-range user are distinctively displayed.

Here, in the case where user D is selected in the display example illustrated in FIG. 2B, the document server 10 transmits the document to the partner terminal apparatus 22 associated with this user D (partner terminal apparatus 22 owned by user D).

Note that reference to a document may be restricted in the case of transmitting the document to an out-of-disclosure-range user as described above.

Specifically, for example, the partner terminal apparatus 22 of an out-of-disclosure-range user may be allowed to refer to the document only in the case where the partner terminal apparatus 22 is at a specific position.

More specifically, for example, the partner terminal apparatus 22 may be allowed to refer to the document only in the case where the partner terminal apparatus 22 is within a predetermined distance from the instruction apparatus 21.

In addition, for example, the partner terminal apparatus 22 may be allowed to refer to the document only in the case where the partner terminal apparatus 22 is within a range in which communication is possible with the instruction apparatus 21.

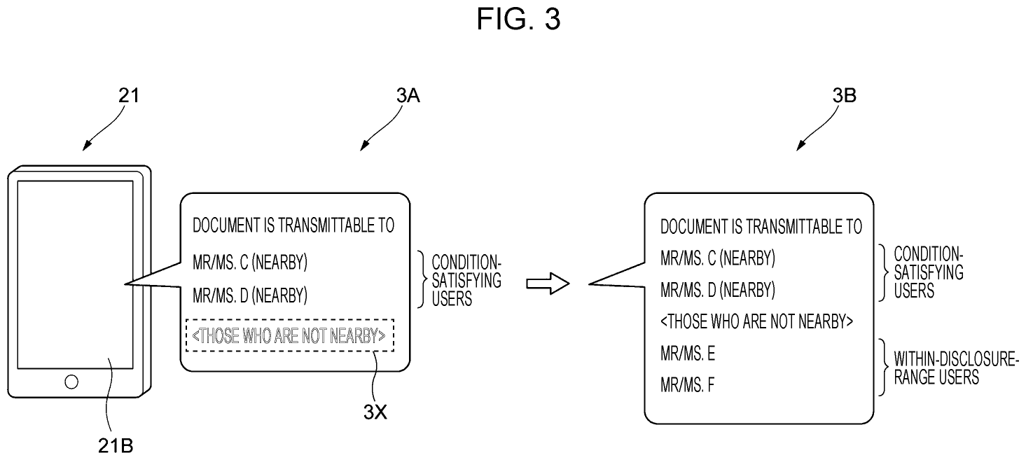

FIG. 3 is a diagram illustrating another display example of the instruction apparatus 21.

In FIG. 3, the case in which a user who is at a distant position from the instruction apparatus 21 but belongs to the disclosure range (hereinafter referred to as a “within-disclosure-range user”) is displayed will be described.

That is, in FIG. 3, the case in which a user associated with a partner terminal apparatus 22 at a position distant from the instruction apparatus 21 but is a within-disclosure-range user who is a user who belongs to the disclosure range is displayed will be described.

A display screen indicated by reference symbol 3A in FIG. 3 illustrates the initial display screen of the instruction apparatus 21.

On this display screen, user C and user D, who are condition-satisfying users (users who are positioned near the instruction apparatus 21 and who belong to the disclosure range) are displayed.

In this display example, when the operator selects a portion indicated by reference symbol 3X on the display screen indicated by reference symbol 3A (a portion displayed as “those who are not nearby”), the display screen is switched to a display screen indicated by reference symbol 3B.

In other words, in this display example, the display screen is switched to a display screen indicated by reference symbol 3B in response to an instruction from an operator (instructor) who operates the instruction apparatus 21 to the instruction apparatus 21.

On the display screen indicated by reference symbol 3B, user E and user F, who are within-disclosure-range users (users who are at positions distant from the instruction apparatus 21 but belong to the disclosure range) are further displayed.

That is, user E and user F, who are within-disclosure-range users, are further displayed on the display screen in addition to user C and user D, who are condition-satisfying users.

In other words, on the display screen indicated by reference symbol 3B, information regarding a user who is not associated with a partner terminal apparatus 22 positioned near the instruction apparatus 21 but belongs to the disclosure range is displayed.

Furthermore, on the display screen indicated by reference symbol 3B, information regarding a user who is associated with a partner terminal apparatus 22 positioned near the instruction apparatus 21 and belongs to the disclosure range is displayed.

Here, condition-satisfying users and within-disclosure-range users are distinctively displayed on the display screen indicated by reference symbol 3B.

Specifically, on this display screen, the text “those who are not nearby” (an image other than an image indicating condition-satisfying users and an image indicating within-disclosure-range users) is displayed between the condition-satisfying users and the within-disclosure-range users, and with this text, the condition-satisfying users and the within-disclosure-range users are distinctively displayed.

Note that the display distinction is not limited to this, and distinction may be made by making text describing a condition-satisfying user and text describing a within-disclosure-range user different.

Specifically, at least one of the color, size, and font of text describing a condition-satisfying user and text describing a within-disclosure-range user is made different, thereby making the text describing a condition-satisfying user different from the text describing a within-disclosure-range user, which in turn makes a condition-satisfying user different from a within-disclosure-range user.

In the display example illustrated in FIG. 3, only condition-satisfying users are displayed, as indicated by reference symbol 3A.

In this display example, within-disclosure-range users are further displayed, as indicated by reference symbol 3B, in response to an instruction from an instructor (in response to an instruction from an operator who operates the instruction apparatus 21 to the instruction apparatus 21).

That is, in the present exemplary embodiment, condition-satisfying users are displayed first and preferentially, and within-disclosure-range users are further displayed in response to an instruction from the operator.

Furthermore, in the present exemplary embodiment, after both the condition-satisfying users and the within-disclosure-range users are displayed, the condition-satisfying users are displayed above the within-disclosure-range users, as indicated by reference symbol 3B. In doing so, the condition-satisfying users are displayed preferentially after both the condition-satisfying users and the within-disclosure-range users are displayed.

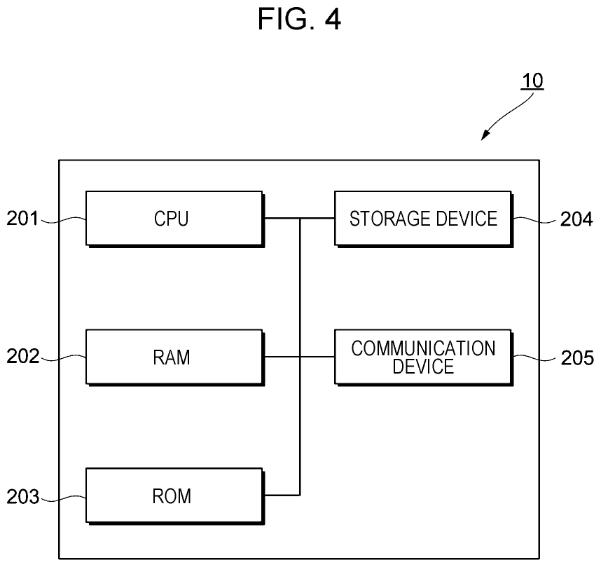

FIG. 4 is a diagram illustrating the configuration of hardware of the document server 10.

The document server 10 includes a CPU 201, a RAM 202, and a ROM 203.

The document server 10 additionally includes a storage device 204, which includes a hard disk, and stores information. The document server 10 further includes a communication device (communication interface (I/F)) 205 for communicating with the outside.

The ROM 203 and the storage device 204 store programs executed by the CPU 201. The CPU 201 reads the programs stored in the ROM 203 and the storage device 204 and, using the RAM 202 as a work area, executes the programs.

By executing, with the use of the CPU 201, the programs stored in the ROM 203 and the storage device 204, later-described function units are realized.

Here, each of the programs executed by the CPU 201 may be provided to the document server 10 in a state where the program is recorded on a computer-readable recording medium such as a magnetic recording medium (including a magnetic tape and a magnetic disk), an optical recording medium (including an optical disk), a magneto-optical recording medium, and a semiconductor memory. Alternatively, each of the programs executed by the CPU 201 may be provided to the document server 10 via communication means such as the Internet.

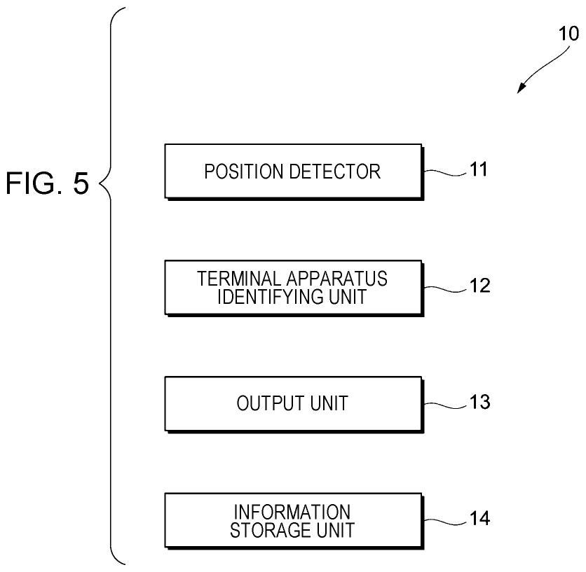

FIG. 5 is a diagram illustrating function units included in the document server 10.

The document server 10 includes a position detector 11, a terminal apparatus identifying unit 12, an output unit 13, and an information storage unit 14.

Here, the position detector 11 and the terminal apparatus identifying unit 12 are realized by the CPU 201, which executes the programs stored in the ROM 203 and the storage device 204.

In addition, the output unit 13 is realized by the communication device 205 and the CPU 201, which executes the programs stored in the ROM 203 and the storage device 204.

In addition, the information storage unit 14 is realized by the storage device 204.

The position detector 11, which serves as an example of a position detector, detects the position of each partner terminal apparatus 22.

Specifically, the position detector 11 according to the present exemplary embodiment uses an apparatus ID transmitted from the instruction apparatus 21 to detect the position of a partner terminal apparatus 22 associated with this apparatus ID.

Specifically, the position detector 11 detects that the position of a partner terminal apparatus 22 associated with the apparatus ID is near the instruction apparatus 21.

In other words, the position detector 11 detects that the position of a partner terminal apparatus 22 associated with the apparatus ID is within a predetermined distance from the instruction apparatus 21. That is, the position detector 11 detects that a partner terminal apparatus 22 associated with the apparatus ID is at a position having a predetermined positional relationship with the instruction apparatus 21.

Although the position detector 11 uses an apparatus ID transmitted from the instruction apparatus 21 to detect the position of a partner terminal apparatus 22 associated with this apparatus ID in the present exemplary embodiment, the method of detecting the position of a partner terminal apparatus 22 is not limited to this method.

Alternatively, for example, the position detector 11 may detect the position of each partner terminal apparatus 22 on the basis of information obtained by the Global Positioning System (GPS) provided on/in the partner terminal apparatus 22.

The terminal apparatus identifying unit 12, which serves as an example of a terminal apparatus identifying unit, identifies a partner terminal apparatus 22 serving as the transmission destination (providing destination) of a document.

Specifically, the terminal apparatus identifying unit 12 identifies, as described above, a partner terminal apparatus 22 positioned at a predetermined position and associated with a user who belongs to the disclosure range of a to-be-provided document as a terminal apparatus 20 to which the document is provided.

That is, the terminal apparatus identifying unit 12 identifies a partner terminal apparatus 22 having a predetermined positional relationship with the instruction apparatus 21 and associated with a user who belongs to the disclosure range of a to-be-provided document as a terminal apparatus 20 to which the document is provided.

More specifically, the terminal apparatus identifying unit 12 identifies a partner terminal apparatus 22 positioned within a predetermined distance from the instruction apparatus 21 (a partner terminal apparatus 22 positioned near the instruction apparatus 21) and associated with a user who belongs to the disclosure range of a to-be-provided document as a terminal apparatus 20 to which the document is provided.

Here, the terminal apparatus identifying unit 12 identifies a partner terminal apparatus 22 to which the document is provided on the basis of two elements, that is, the position of the partner terminal apparatus 22 and whether a user associated with the partner terminal apparatus 22 belongs to the document's disclosure range.

However, how the partner terminal apparatus 22 is identified is not limited to the above, and the partner terminal apparatus 22 may be identified additionally on the basis of time element, as described later.

Specifically, the terminal apparatus identifying unit 12 may identify a partner terminal apparatus 22 positioned at a predetermined position at a predetermined time and associated with a user who belongs to the disclosure range of a document as a partner terminal apparatus 22 to which the document is provided.

The output unit 13, which serves as an example of an output unit, transmits information regarding the above-mentioned predetermined position and information regarding the above-mentioned predetermined time to each partner terminal apparatus 22.

The information storage unit 14 holds various types of information, such as a document (document information), a document ID, an apparatus ID, and information regarding a user.

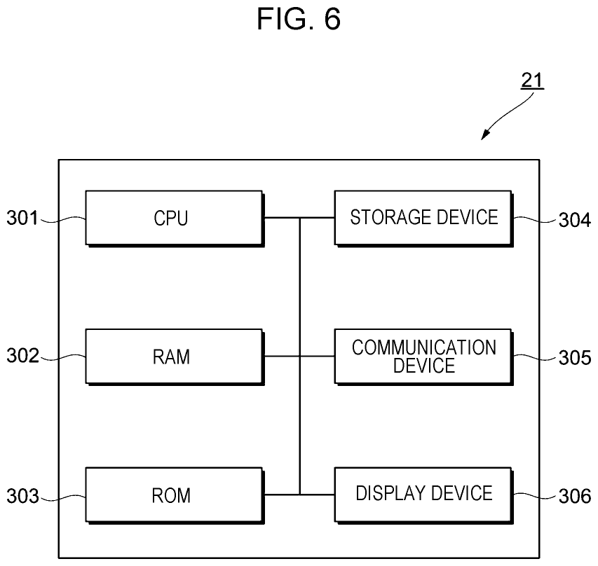

FIG. 6 is a diagram illustrating the configuration of hardware of the instruction apparatus 21. Note that the partner terminal apparatus 22 has the same hardware configuration as the instruction apparatus 21.

The instruction apparatus 21 includes a CPU 301, a RAM 302, and a ROM 303.

The instruction apparatus 21 additionally includes a storage device 304, which includes a flash memory, and stores information. The instruction apparatus 21 further includes a communication device (communication I/F) 305 for communicating with the outside. The instruction apparatus 21 additionally includes a display device 306, which displays information.

The ROM 303 and the storage device 304 store programs executed by the CPU 301. The CPU 301 reads the programs stored in the ROM 303 and the storage device 304 and, using the RAM 302 as a work area, executes the programs.

By executing, with the use of the CPU 301, the programs stored in the ROM 303 and the storage device 304, later-described function units are realized.

Here, each of the programs executed by the CPU 301 may be provided to the instruction apparatus 21 in a state where the program is recorded on a computer-readable recording medium such as a magnetic recording medium (including a magnetic tape and a magnetic disk), an optical recording medium (including an optical disk), a magneto-optical recording medium, and a semiconductor memory. Alternatively, each of the programs executed by the CPU 301 may be provided to the instruction apparatus 21 via communication means such as the Internet.

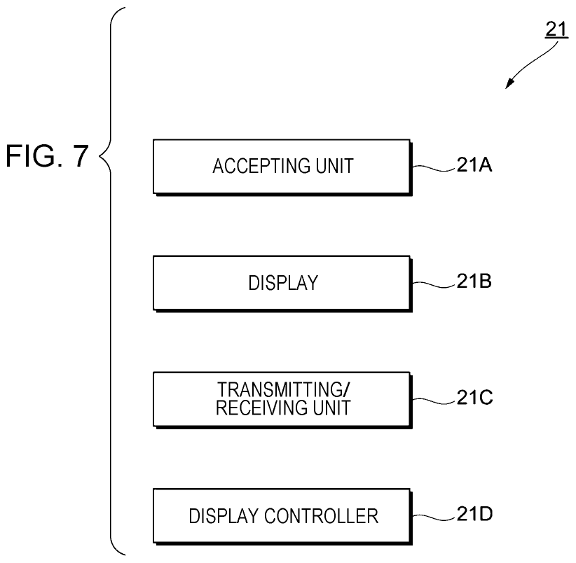

FIG. 7 is a diagram illustrating function units included in the instruction apparatus 21.

The instruction apparatus 21 includes an accepting unit 21A, the display 21B, a transmitting/receiving unit 21C, and a display controller 21D.

Here, the accepting unit 21A and the display controller 21D are realized by the CPU 301, which executes the programs stored in the ROM 303 and the storage device 304.

In addition, the display 21B is realized by the display device 306. The display device 306 includes, for example, a touchscreen display.

In addition, the transmitting/receiving unit 21C is realized by the communication device 305 and the CPU 301, which executes the programs stored in the ROM 303 and the storage device 304.

The accepting unit 21A, which serves as an example of an accepting unit, accepts selection of a document to be transmitted to the partner terminal apparatus 22.

Specifically, in the present exemplary embodiment, the operator performs an operation on the display 21B of the instruction apparatus 21 to select a document to be transmitted to the partner terminal apparatus 22, and the accepting unit 21A accepts this selection of the document.

The display 21B displays information for the operator. Specifically, the display 21B displays information regarding a condition-satisfying user, a within-disclosure-range user, and an out-of-disclosure-range user, as described above.

The transmitting/receiving unit 21C transmits/receives information to/from an external device such as the document server 10.

Specifically, the transmitting/receiving unit 21C transmits a document transmission instruction given from the operator to the document server 10. In addition, the transmitting/receiving unit 21C transmits the document ID of a document selected by the operator, the apparatus ID of a partner terminal apparatus 22 positioned near the instruction apparatus 21, and so forth to the document server 10. In addition, the transmitting/receiving unit 21C receives information regarding one or more candidates for a transmission destination (information regarding one or more condition-satisfying users) transmitted from the document server 10.

The display controller 21D, which serves as an example of a display controller, controls display of the display 21B of the instruction apparatus 21.

Specifically, the display controller 21D changes display of the display 21B regarding the transmission destination of the document in accordance with an identification result obtained by the terminal apparatus identifying unit 12 included in the document server 10.

More specifically, the display controller 21D displays information regarding a user identified by the terminal apparatus identifying unit 12 (information on a condition-satisfying user and the like) on the display 21B. In addition, in the case where the terminal apparatus 20 identified by the terminal apparatus identifying unit 12 changes to another terminal apparatus 20, the display controller 21D displays information regarding a user associated with the terminal apparatus 20 after the change.

In the present exemplary embodiment, in response to identification of one or more partner terminal apparatuses 22 by the terminal apparatus identifying unit 12, information regarding a user associated with each of the partner terminal apparatus(es) 22 is transmitted to the instruction apparatus 21.

The display controller 21D of the instruction apparatus 21 displays the transmitted information regarding a user on the display 21B. In addition, in the case where information regarding a user is newly transmitted, the display controller 21D changes the display details of the display 21B and displays the new information regarding a user.

In addition, the display controller 21D changes (increases or decreases) the number of displayed transmission destinations of the document, displayed on the instruction apparatus 21, in accordance with the identification result obtained by the terminal apparatus identifying unit 12.

More specifically, in the present exemplary embodiment, user names indicating transmission destinations of the document are displayed on the instruction apparatus 21, as illustrated in FIGS. 2A, 2B, and 3.

The display controller 21D changes the number of displayed user names in accordance with the identification result obtained by the terminal apparatus identifying unit 12. That is, the display controller 21D changes the number of displayed user names in response to a change of the identification result obtained by the terminal apparatus identifying unit 12 if there is such a change.

Furthermore, as described above, the display controller 21D displays information regarding a within-disclosure-range user(s) on the display 21B of the instruction apparatus 21, as indicated by reference symbol 3B in FIG. 3.

That is, the display controller 21D basically displays information regarding a condition-satisfying user(s) on the instruction apparatus 21; however, if it is set to additionally display information regarding a within-disclosure-range user, the display controller 21D also displays information regarding a within-disclosure-range user(s).

In the case of displaying information regarding a within-disclosure-range user(s), the display controller 21D distinctively displays information regarding a condition-satisfying user(s) and information regarding a within-disclosure-range user(s), as indicated by reference symbol 3B in FIG. 3.

That is, in the present exemplary embodiment, both information regarding a condition-satisfying user(s) and information regarding a within-disclosure-range user(s) may be displayed, as illustrated in FIG. 3. In the case of displaying these two items of information, these two items of information are distinctively displayed to make it clear that they are different items of information.

Furthermore, the display controller 21D displays information regarding a within-disclosure-range user(s) in response to an instruction given from the instructor, as illustrated in FIG. 3.

The display controller 21D displays information regarding an out-of-disclosure-range user (a user positioned near the instruction apparatus 21 but is outside the disclosure range) on the display 21B of the instruction apparatus 21, as illustrated in FIG. 2B.

Specifically, the display controller 21D displays information regarding an out-of-disclosure-range user(s) on the display 21B of the instruction apparatus 21 in the case where it is set to additionally display information regarding an out-of-disclosure-range user(s).

In addition, in the case of displaying information regarding an out-of-disclosure-range user(s), the display controller 21D distinctively displays information regarding an out-of-disclosure-range user(s) and information regarding a condition-satisfying user(s), as illustrated in FIG. 2B.

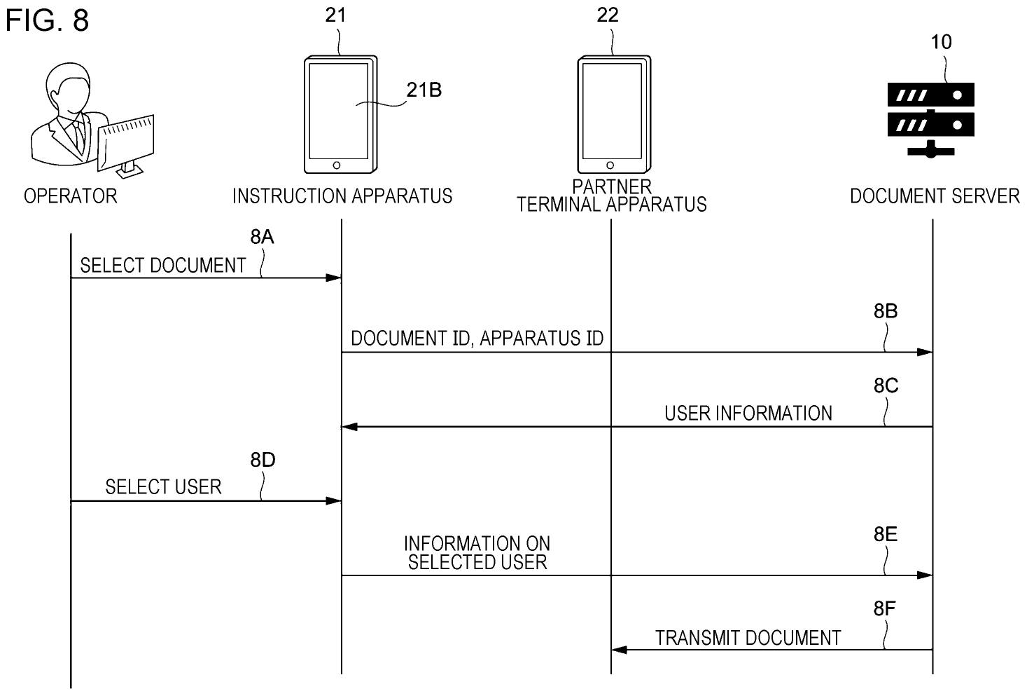

FIG. 8 is a diagram illustrating the flow of a process executed in the information processing system 1.

In the present exemplary embodiment, at first, as indicated by reference symbol 8A, an operator who operates the instruction apparatus 21 performs an operation on the instruction apparatus 21 to select a to-be-transmitted document.

In doing so, the accepting unit 21A of the instruction apparatus 21 accepts this selection of a document, performed by the operator. Next, the operator gives an instruction to transmit the document via the instruction apparatus 21.

In response to the transmission instruction, as indicated by reference symbol 8B, the instruction apparatus 21 transmits to the document server 10 information regarding the selected document (document ID) and the apparatus ID of a partner terminal apparatus 22 positioned near the instruction apparatus 21 (information regarding the partner terminal apparatus 22).

In the document server 10, the position detector 11 detects the position of a partner terminal apparatus 22 associated with the apparatus ID transmitted from the instruction apparatus 21. Specifically, the position detector 11 detects that the position of a partner terminal apparatus 22 associated with this apparatus ID is near the instruction apparatus 21.

As described above, note that detection of the position of the partner terminal apparatus 22 is not limited to this, and the position of each partner terminal apparatus 22 may be detected on the basis of position information obtained from GPS provided on/in the partner terminal apparatus 22.

Next, the terminal apparatus identifying unit 12 identifies a terminal apparatus 20 serving as the destination to which the document is provided.

Specifically, the terminal apparatus identifying unit 12 identifies, as described above, a partner terminal apparatus 22 positioned at a predetermined position and associated with a user who belongs to the disclosure range of the to-be-provided document as a terminal apparatus 20 to which the document is provided.

In this example, as described above, the terminal apparatus identifying unit 12 identifies a partner terminal apparatus 22 positioned near the instruction apparatus 21 and associated with a user who belongs to the disclosure range of the to-be-provided document as a terminal apparatus 20 to which the document is provided.

Thereafter, the document server 10 identifies a user associated with the terminal apparatus 20 (partner terminal apparatus 22) identified by the terminal apparatus identifying unit 12, and, as indicated by reference symbol 8C, transmits information regarding the identified user to the instruction apparatus 21.

Accordingly, information regarding a condition-satisfying user is displayed on the display 21B of the instruction apparatus 21, such as that illustrated in FIG. 2A.

Depending on the settings, the terminal apparatus identifying unit 12 may identify a partner terminal apparatus 22 that is not near the instruction apparatus 21 but is associated with a user who belongs to the document's disclosure range as a terminal apparatus 20 to which the document is provided.

In this case, as indicated by reference symbol 3B in FIG. 3, a within-disclosure-range user(s) is displayed, besides a condition-satisfying user(s), on the instruction apparatus 21.

In addition, depending on the settings, the terminal apparatus identifying unit 12 may identify a partner terminal apparatus 22 that is positioned near the instruction apparatus 21 but is associated with a user who does not belong to the document's disclosure range as a terminal apparatus 20 to which the document is provided.

In this case, as illustrated in FIG. 2B, an out-of-disclosure-range user(s) is displayed, besides a condition-satisfying user(s), on the instruction apparatus 21.

Thereafter, in this process example, as indicated by reference symbol 8D in FIG. 8, the operator performs an operation on the instruction apparatus 21 to select a user serving as the document's transmission destination from among users (candidates for the transmission destination) displayed on the instruction apparatus 21.

As indicated by reference symbol 8E, information regarding the selected user is transmitted to the document server 10. As indicated by reference symbol 8F, the document server 10 transmits the document selected by the operator to a partner terminal apparatus 22 associated with each selected user.

In the present exemplary embodiment, the display format of the instruction apparatus 21 is selectable by the operator, although a description thereof is omitted above. In accordance with this selection, the display format is changed.

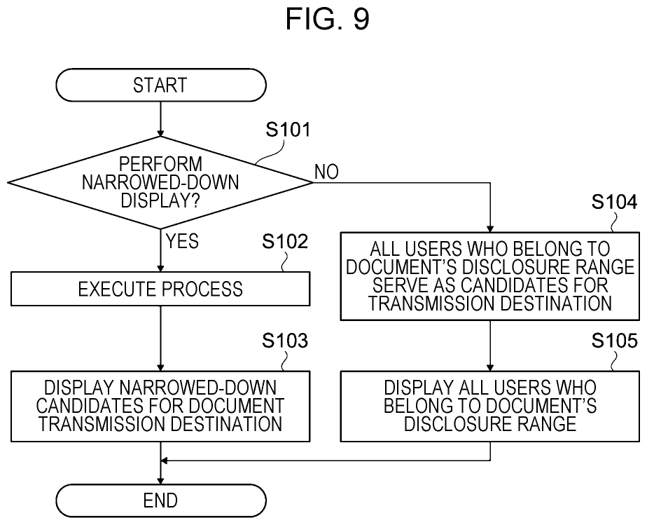

FIG. 9 is a diagram describing a process of changing the display format.

In the present exemplary embodiment, in response to a predetermined operation performed by the operator on the instruction apparatus 21, a screen for selecting the display format is displayed. In other words, a screen for making an inquiry as to whether to perform display with narrowed-down destinations is displayed.

More specifically, an inquiry is made as to whether to display candidates for a transmission destination that are narrowed down to users who are positioned near the instruction apparatus 21. In the present exemplary embodiment, the operator performs an operation on the instruction apparatus 21 to select the display format.

Next, in the present exemplary embodiment, in step S101, the instruction apparatus 21 determines whether to narrow down the to-be-displayed users to those who are positioned near the instruction apparatus 21 (hereinafter referred to as “narrowed-down display”) on the basis of the details of selection made by the operator.

In the case where it is determined in step S101 to perform narrowed-down display, the above-described processing (transmission of the document ID and the apparatus ID to the document server 10, identification of a partner terminal apparatus 22 serving as the document's transmission destination, identification of a user serving as the document's transmission destination, and transmission of information regarding the identified user to the instruction apparatus 21) is performed (step S102).

Accordingly, the display 21B of the instruction apparatus 21 displays the narrowed-down candidates for the document's transmission destination (user names serving as the document's transmission destination) (step S103). In other words, the display 21B of the instruction apparatus 21 displays one or more users who belong to the document's disclosure range and who are positioned near the instruction apparatus 21.

In contrast, in the case where it is determined in step S101 not to perform narrowed-down display, all users who belong to the document's disclosure range serve as candidates for the transmission destination (step S104).

In this case, information regarding all the users is displayed on the display 21B of the instruction apparatus 21 (step S105). In other words, in this case, candidates for the transmission destination are not narrowed down, and information regarding all the users who belong to the document's disclosure range is displayed on the display 21B of the instruction apparatus 21.

Although the case in which a partner terminal apparatus 22 positioned near the instruction apparatus 21 is identified as the document's transmission destination has been described above, the document's transmission destination is not limited to a partner terminal apparatus 22 positioned near the instruction apparatus 21.

A partner terminal apparatus 22 positioned at a predetermined position, irrespective of the position of the instruction apparatus 21, may be identified as a partner terminal apparatus 22 to which the document is transmitted.

Specifically, for example, a partner terminal apparatus 22 positioned in a seminar venue or a meeting room and associated with a user who belongs to the disclosure range of a to-be-transmitted document may be identified as a partner terminal apparatus 22 to which the document is transmitted.

Here, for example, there are cases in which, in a seminar venue or at a meeting, it is desired to provide a document to participants of the seminar or the meeting who are within the document's disclosure range.

In this case, it is bothersome to provide a document to the participants using paper, USB memory, or the like. Furthermore, if there are participants who arrive late, it is necessary to provide a document to these participants during the meeting or the like, which further complicates the operation.

In contrast, in the configuration of the present exemplary embodiment, a document is automatically provided to a partner terminal apparatus 22 when the partner terminal apparatus 22 arrives at a seminar venue or a meeting room, thereby alleviating the burden of providing a document.

In other words, it becomes unnecessary to correspond to every participant whenever he/she arrives at a seminar venue or a meeting room, thereby alleviating the burden of providing a document.

Whether or not each partner terminal apparatus 22 is at a predetermined position such as a seminar venue or a meeting room may be determined by, for example, providing an apparatus corresponding to the above-mentioned instruction apparatus 21 at this predetermined position. In this case, whenever the instruction apparatus 21 detects radio waves from each partner terminal apparatus 22, it means that the partner terminal apparatus 22 is positioned at the predetermined position.

Alternatively, whether or not each partner terminal apparatus 22 is at a predetermined position may be detected on the basis of signals from GPS provided on/in the partner terminal apparatus 22.

Alternatively, the terminal apparatus identifying unit 12 may identify a partner terminal apparatus 22 associated with a user who belongs to the document's disclosure range and positioned at a predetermined position at a predetermined time as a terminal apparatus 20 to which the document is provided.

Specifically, for example, the terminal apparatus identifying unit 12 may identify a partner terminal apparatus 22 positioned in a seminar venue or a meeting room between 13:00 and 14:00 as a terminal apparatus 20 to which the document is provided.

Here, in the configuration of providing a document to a partner terminal apparatus 22 only on the basis of the position of the partner terminal apparatus 22, if the accuracy of detecting the position of the partner terminal apparatus 22 is low, there is a possibility that a document is provided to those who are not supposed to receive the document in the first place.

In contrast, when each partner terminal apparatus 22 is identified by additionally taking time into consideration as described above, partner terminal apparatuses 22 to which a document is provided are further narrowed down. Compared with the case in which each partner terminal apparatus 22 is identified only on the basis of the position of the partner terminal apparatus 22, it becomes less likely for a document to be provided to those who are not supposed to receive the document in the first place.

Furthermore, in the case where each partner terminal apparatus 22 is identified by additionally taking time into consideration, if destinations to which a document is provided are narrowed down to users who belong to the disclosure range, the document is prevented from being provided to those who accidentally visit a seminar venue or a meeting room.

In this case (the case in which a document is provided to a partner terminal apparatus 22 positioned in a seminar venue or a meeting room), reference to a document may be restricted.

Specifically, for example, a partner terminal apparatus 22 is allowed to refer to a document only in the case where the partner terminal apparatus 22 is at a predetermined position such as a seminar venue or a meeting room. When the partner terminal apparatus 22 is no longer at the predetermined position, the partner terminal apparatus 22 may be restricted to refer the document.

As described above, in the case of providing a document to a partner terminal apparatus 22 at a predetermined position at a predetermined time, the output unit 13 of the document server 10 outputs (transmits) information regarding this predetermined position and information regarding this predetermined time to each partner terminal apparatus 22 in the present exemplary embodiment.

In other words, the output unit 13 outputs information regarding the place and time for providing a document to each partner terminal apparatus 22.

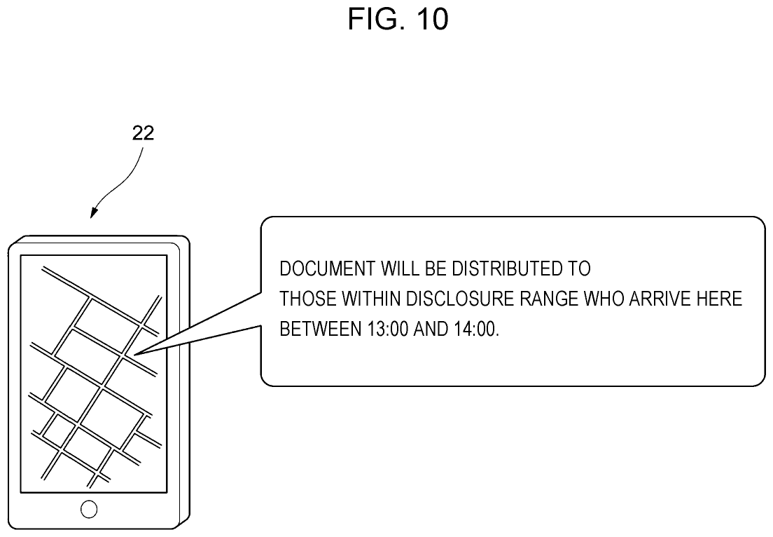

FIG. 10 is a diagram illustrating a display screen of the partner terminal apparatus 22 in the case where information regarding a place and a time for providing a document is output to the partner terminal apparatus 22.

A map is displayed on this display screen, and it is further displayed on the display screen that a portion of the map is designated, thereby indicating the place for providing the document. On the display screen, it is displayed that the time for providing the document is between 13 o'clock and 14 o'clock.

The user of the partner terminal apparatus 22 arrives at the displayed providing place at the displayed providing time to receive the document.

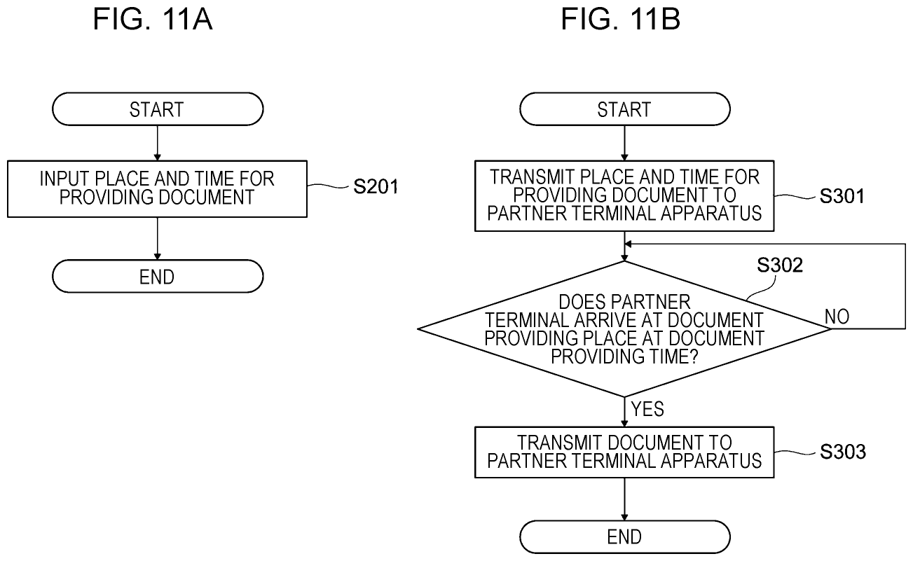

FIGS. 11A and 11B are diagrams illustrating the flow of a process in the case of providing a document at a predetermined position at a predetermined time.

In this process, the operator first operates the instruction apparatus 21 to input a place and a time for providing the document (S201).

In the present exemplary embodiment, the input information is transmitted from the instruction apparatus 21 to the document server 10.

The document server 10 obtains the transmitted information (information regarding the place and time for providing the document). The output unit 13 of the document server 10 transmits the obtained information to each partner terminal apparatus 22 registered in the document server 10 (step S301).

Thereafter, when the time for providing the document comes, the document server 10 monitors the position of each partner terminal apparatus 22 (specifically, for example, monitors an output from the instruction apparatus 21 provided at the place for providing the document), and determines whether or not the partner terminal apparatus 22 of a user who belongs to the document's disclosure range arrives at the place for providing the document (step S302).

In the case where the partner terminal apparatus 22 of a user who belongs to the document's disclosure range arrives at the place for providing the document, the document server 10 transmits the document to this partner terminal apparatus 22 (step S303).

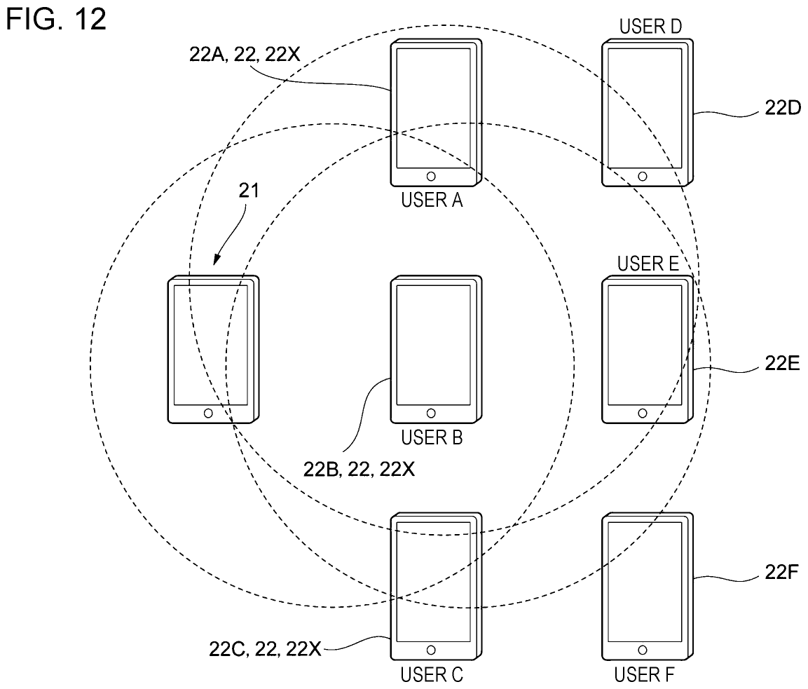

FIG. 12 is a diagram describing another example of a document providing form.

In the document providing form illustrated in FIG. 12, there are partner terminal apparatuses 22 that are not positioned near the instruction apparatus 21. In this document providing form, a document is also transmitted to these partner terminal apparatuses 22 that are not nearby.

Specifically, in this document providing form, although partner terminal apparatuses 22D, 22E, and 22F (partner terminal apparatuses 22D, 22E, and 22F associated with users D, E, and F) are not positioned near the instruction apparatus 21, the document is also transmitted to these partner terminal apparatuses 22D, 22E, and 22F.

More specifically, in this document providing form, although the partner terminal apparatus 22D is not positioned near the instruction apparatus 21, because the partner terminal apparatus 22D is positioned near two partner terminal apparatuses 22, namely, a partner terminal apparatus 22A and a partner terminal apparatus 22B, the document is transmitted to the partner terminal apparatus 22D.

Likewise, although the partner terminal apparatus 22E is not positioned near the instruction apparatus 21, because the partner terminal apparatus 22E is positioned near three partner terminal apparatuses 22, namely, the partner terminal apparatuses 22A to 22C, the document is transmitted additionally to the partner terminal apparatus 22E.

In addition, although the partner terminal apparatus 22F is not positioned near the instruction apparatus 21, because the partner terminal apparatus 22F is positioned near two partner terminal apparatuses 22, namely, the partner terminal apparatus 22B and the partner terminal apparatus 22C, the document is transmitted additionally to the partner terminal apparatus 22F.

In this document providing form illustrated in FIG. 12, the document is transmitted not only to partner terminal apparatuses 22 positioned near the instruction apparatus 21, but also to partner terminal apparatuses 22 that are each positioned near a partner terminal apparatus 22 that has already (actually) received the provided document (hereinafter referred to as an “information-received terminal apparatus 22X”).

Specifically, in this providing form, the partner terminal apparatus 22A, the partner terminal apparatus 22B, and the partner terminal apparatus 22C correspond to the above-mentioned information-received terminal apparatuses 22X.

In this providing form, the document is also transmitted to the partner terminal apparatuses 22D, 22E, and 22F, which are positioned near the partner terminal apparatus 22A, the partner terminal apparatus 22B, and the partner terminal apparatus 22C, which are information-received terminal apparatuses 22X.

Note that the document is not transmitted uniformly to the partner terminal apparatuses 22D, 22E, and 22F in this providing form. Instead, the document is transmitted to the partner terminal apparatuses 22D, 22E, and 22F in the case where information-received terminal apparatuses 22X, the number of which exceeds a predetermined number, are positioned within a predetermined distance from each of the partner terminal apparatuses 22D, 22E, and 22F.

Specifically, in this configuration example, the document is transmitted to the partner terminal apparatuses 22D, 22E, and 22F in the case where two or more information-received terminal apparatuses 22X are positioned within a predetermined distance from each of the partner terminal apparatuses 22D, 22E, and 22F.

In this example, two information-received terminal apparatuses 22X, namely, the partner terminal apparatus 22A and the partner terminal apparatus 22B, are positioned around the partner terminal apparatus 22D, and the document is transmitted to the partner terminal apparatus 22D.

In addition, three information-received terminal apparatuses 22X, namely, the partner terminal apparatuses 22A to 22C, are positioned around the partner terminal apparatus 22E, and the document is transmitted to the partner terminal apparatus 22E.

In addition, two information-received terminal apparatuses 22X, namely, the partner terminal apparatus 22B and the partner terminal apparatus 22C, are positioned around the partner terminal apparatus 22F, and the document is transmitted to the partner terminal apparatus 22F.

In the document providing form illustrated in FIG. 1 and so forth, because the partner terminal apparatuses 22D, 22E, and 22F are distant from the instruction apparatus 21, the document is not transmitted to the partner terminal apparatuses 22D, 22E, and 22F in the document providing form illustrated in FIG. 1 and so forth.

In contrast, in the document providing form illustrated in FIG. 12, the document is transmitted additionally to one or more partner terminal apparatuses 22 distant from the instruction apparatus 21. In doing so, the document is transmitted to more partner terminal apparatuses 22.

Note that the following document providing form is also conceivable: the document is transmitted to the partner terminal apparatuses 22D, 22E, and 22F even in the case where there is only one information-received terminal apparatus 22X within a predetermined distance from each of the partner terminal apparatuses 22D, 22E, and 22F.

By the way, in this case, information is more likely to be transmitted to a partner terminal apparatus 22 positioned at a point far from the instruction apparatus 21.

In contrast, in the present exemplary embodiment, as described above, the document is transmitted to the partner terminal apparatuses 22D, 22E, and 22F in the case where multiple information-received terminal apparatuses 22X are positioned within a predetermined distance from each of the partner terminal apparatuses 22D, 22E, and 22F.

In this case, provision of the document to partner terminal apparatuses 22 is restricted, compared with the case in which the document is provided to the partner terminal apparatuses 22D, 22E, and 22F even in the case where there is only one information-received terminal apparatus 22X positioned within a predetermined distance from each of the partner terminal apparatuses 22D, 22E, and 22F.

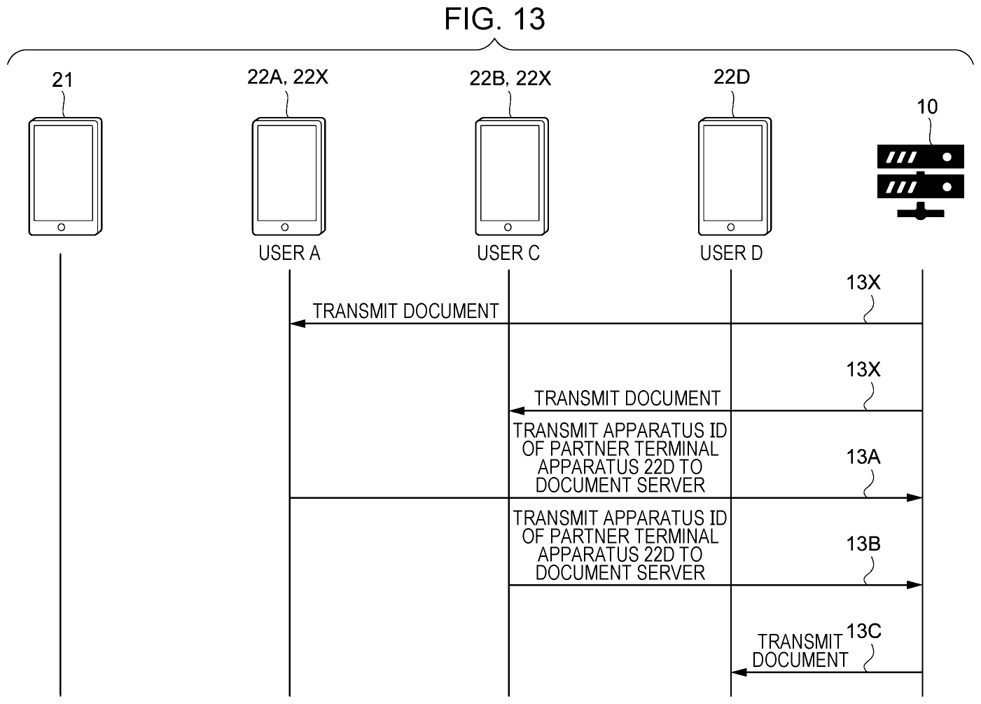

FIG. 13 is a diagram illustrating the flow of a process in the case of providing a document in the document providing form illustrated in FIG. 12.

In FIG. 13, the flow of a process in the case where the document server 10 first provides the document to the partner terminal apparatuses 22A and 22B (information-received terminal apparatuses 22X), and then the document server 10 provides the document to the partner terminal apparatus 22D will be described by way of example.

In this processing example, at first, the above-described process is performed, and, as indicated by reference symbol 13X, the document server 10 provides the document to the partner terminal apparatuses 22A and 22B (information-received terminal apparatuses 22X).

Thereafter, when the partner terminal apparatus 22A (information-received terminal apparatus 22X) detects the partner terminal apparatus 22D, as indicated by reference symbol 13A, the partner terminal apparatus 22A transmits the apparatus ID of the partner terminal apparatus 22D to the document server 10.

That is, the partner terminal apparatus 22A transmits the apparatus ID of the partner terminal apparatus 22D to the document server 10 in the case where the partner terminal apparatus 22D is positioned within the communication range of the partner terminal apparatus 22A.

Likewise, when the partner terminal apparatus 22B (information-received terminal apparatus 22X) detects the partner terminal apparatus 22D, as indicated by reference symbol 13B, the partner terminal apparatus 22B transmits the apparatus ID of the partner terminal apparatus 22D to the document server 10.

That is, the partner terminal apparatus 22B transmits the apparatus ID of the partner terminal apparatus 22D to the document server 10 in the case where the partner terminal apparatus 22D is positioned within the communication range of the partner terminal apparatus 22B.

In the case where the document server 10 receives the same apparatus ID from the partner terminal apparatuses 22A and 22B, which are two partner terminal apparatuses 22 (two information-received terminal apparatuses 22X), the document server 10 identifies the partner terminal apparatus 22D associated with this apparatus ID.

In the case where a user associated with this identified partner terminal apparatus 22D belongs to the disclosure range of the to-be-provided document, the document server 10 identifies the partner terminal apparatus 22D as a terminal apparatus 20 to which the document is provided.

As indicated by reference symbol 13C, the document server 10 transmits the document to the identified partner terminal apparatus 22D.

By the way, in this document providing form, the partner terminal apparatus 22D or the like which has newly received the provided document becomes a new information-received terminal apparatus 22X. In this case, if another new partner terminal apparatus 22 is positioned near this new information-received terminal apparatus 22X, the document is also transmitted to this other new partner terminal apparatus 22.

Furthermore, in this case, this other new partner terminal apparatus 22 becomes a new information-received terminal apparatus 22X. If yet another new partner terminal apparatus 22 is positioned near this new information-received terminal apparatus 22X, the document is also transmitted to this other new partner terminal apparatus 22.

That is, in this document providing form, the document is repeatedly provided to a new partner terminal apparatus 22 that is positioned near a new information-received terminal apparatus 22X.

Here, the above-mentioned number of information-received terminal apparatuses 22X, which serves as a reference for determining whether or not to provide the document, may be changed in accordance with the above-mentioned number of times the document is repeatedly provided.

Specifically, although the document is provided to a partner terminal apparatus 22 in the case where the number of information-received terminal apparatuses positioned near this partner terminal apparatus 22 is two or more, this number may be increased in accordance with the above-described number of times the document is repeatedly provided. In this case, the document is suppressed from unlimitedly provided.

### Others

The case in which the document is provided to a partner terminal apparatus 22 positioned at a predetermined position has been described above by way of example. In the case of providing the document to this partner terminal apparatus 22 positioned at the predetermined position, the document may be provided only to a partner terminal apparatus 22 that stays at this predetermined position for longer than a predetermined period of time.

In this case, the document is suppressed from being provided to a partner terminal apparatus 22 that only passes the predetermined position in a short period of time.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising:
a position detector that detects a position of a terminal apparatus capable of receiving information that is provided; and
a terminal apparatus identifying unit that identifies, as a terminal apparatus to which the information is provided, a terminal apparatus positioned at a predetermined position and associated with a user who belongs to a disclosure range of the information that is provided.

2. The information processing system according to claim 1, wherein the terminal apparatus identifying unit identifies, as a terminal apparatus to which the information is provided, a terminal apparatus that has a predetermined positional relationship with an instruction apparatus that gives an instruction to transmit the information that is provided, and that is associated with a user who belongs to the disclosure range of the information.

3. The information processing system according to claim 2, wherein the terminal apparatus identifying unit identifies, as a terminal apparatus to which the information is provided, a terminal apparatus that is within a predetermined distance from the instruction apparatus and that is associated with a user who belongs to the disclosure range of the information.

4. The information processing system according to claim 1, further comprising:
a display controller that changes display of an instruction apparatus that gives an instruction to transmit the information that is provided, the display regarding a destination to which the information is provided, in accordance with an identification result obtained by the terminal apparatus identifying unit.

5. The information processing system according to claim 4, wherein the display controller changes a number of displayed destinations to which the information is provided, which is displayed on the instruction apparatus, in accordance with the identification result obtained by the terminal apparatus identifying unit.

6. The information processing system according to claim 1, further comprising:
a display controller that displays, on an instruction apparatus that gives an instruction to transmit the information that is provided, information regarding a user associated with a terminal apparatus identified by the terminal apparatus identifying unit.

7. The information processing system according to claim 1, further comprising:
a display controller that displays, on an instruction apparatus that gives an instruction to transmit the information that is provided, information regarding a user who is associated with a terminal apparatus not positioned at the predetermined position but who belongs to the disclosure range.

8. The information processing system according to claim 7, wherein the display controller distinctively displays the information regarding a user who is associated with a terminal apparatus not positioned at the predetermined position but who belongs to the disclosure range and the information regarding a user who is associated with a terminal apparatus positioned at the predetermined position and who belongs to the disclosure range.

9. The information processing system according to claim 7, wherein the display controller displays, in response to an instruction from an instructor, the information regarding a user who is associated with a terminal apparatus not positioned at the predetermined position but who belongs to the disclosure range.

10. The information processing system according to claim 1, further comprising:
a display controller that displays, on an instruction apparatus that gives an instruction to transmit the information that is provided, information regarding a user who is associated with a terminal apparatus positioned at the predetermined position but who does not belong to the disclosure range.

11. The information processing system according to claim 10, wherein the display controller distinctively displays the information regarding a user who is associated with a terminal apparatus positioned at the predetermined position but who does not belong to the disclosure range and the information regarding a user who is associated with a terminal apparatus positioned at the predetermined position and who belongs to the disclosure range.

12. The information processing system according to claim 1, wherein the terminal identifying unit identifies, as a terminal apparatus to which the information is provided, a terminal apparatus positioned at the predetermined position at a predetermined time.

13. The information processing system according to claim 12, further comprising:
an output unit that outputs information regarding the predetermined position and information regarding the predetermined time to the terminal apparatus.

14. The information processing system according to claim 1, wherein:
the information is transmitted to another terminal apparatus positioned around an information-received terminal apparatus that is identified as a terminal apparatus to which the information is provided and that has actually received the information that is provided, and
the information is transmitted to the other terminal apparatus in a case where one or more information-received terminal apparatuses, a number of which exceeds a predetermined number, are positioned within a predetermined distance from the other terminal apparatus.

15. An information processing apparatus comprising:
an accepting unit that accepts selection of information to be transmitted;
a display that displays information; and
a display controller that displays information regarding a recipient of the information on the display, the display controller displaying information regarding a recipient who is positioned at a predetermined position and belongs to a disclosure range of the information.

16. The information processing apparatus according to claim 15, wherein the display controller further displays, on the display, information regarding a recipient who is not positioned at the predetermined position but belongs to the disclosure range.

17. The information processing apparatus according to claim 15, wherein the display controller further displays, on the display, information regarding a recipient who does not belong to the disclosure range but is positioned at the predetermined position.

18. A non-transitory computer readable medium storing a program causing a computer to execute a process, the process comprising:
detecting a position of a terminal apparatus capable of receiving information that is provided; and
identifying, as a terminal apparatus to which the information is provided, a terminal apparatus positioned at a predetermined position and associated with a user who belongs to a disclosure range of the information that is provided.
